(19) United States
(12) Patent Application Publication
(10) Pub. No.: US 2016/0082547 A1
(43) Pub. Date: Mar. 24, 2016

(54) COMPONENT OR COUPON FOR BEING USED UNDER HIGH THERMAL AND STRESS LOAD AND METHOD FOR MANUFACTURING SUCH COMPONENT OR COUPON

(71) Applicant: ALSTOM Technology Ltd, Baden (CH)

(72) Inventors: Jaroslaw Leszek SZWEDOWICZ, Bad Zurzach (CH); Lukas Emanuel RICHENBACHER, Basel (CH)

(73) Assignee: ALSTOM Technology Ltd, Baden (CH)

(21) Appl. No.: 14/959,004

(22) Filed: Dec. 4, 2015

Related U.S. Application Data
(62) Division of application No. 13/664,662, filed on Oct. 31, 2012.

(30) Foreign Application Priority Data
Oct. 31, 2011 (CH) 01755/11

(51) Int. Cl. B23K 26/342; G05B 19/4099

(52) U.S. Cl. CPC B23K 26/342; G05B 19/4099; B33Y 10/00

(57) ABSTRACT

A component or coupon for use in a thermal machine under extreme thermal and mechanical conditions comprises an alloy material having a controllable grain size (d). A grain size distribution (d(X,Y,Z)) of the component or coupon corresponds to at least one of an expected temperature distribution (T(X,Y,Z)), an expected stress distribution (σ(X,Y,Z)) and an expected strain distribution (ε(X,Y,Z)), which vary with geometrical coordinates (X,Y,Z) of the component or coupon, such that a lifetime of the component or coupon is improved with respect to a similar component or coupon having a substantially uniform grain size.

### CROSS-REFERENCE TO PRIOR APPLICATION

Priority is claimed to Swiss Patent Application No. CH 01755/11, filed on Oct. 31, 2011, the entire disclosure of which is hereby incorporated by reference herein.

### FIELD

The present invention relates to the configuration and manufacturing of components or coupons (i.e. a part of a component, preferably used for repairing the component), especially for gas turbines, which are used under extreme thermal and mechanical conditions and to a method for manufacturing such component or coupon.

### BACKGROUND

Components of gas turbines or other thermal machines, e.g. rotating blades or the like, are subject to severe operating conditions. In general, grain size has an impact on the lifetime of a component made of metal and/or ceramic alloys. Depending on the operating temperatures or stresses, the component can suffer from various failure mechanisms that are described as Low-Cycle Fatigue (LCF), Thermo-Mechanical Fatigue (TMF), Creep, Oxidation, as well as High-Cycle Fatigue (HCF) damages. In terms of the operation condition, the designed system can be loaded by one or more damage mechanisms, as they are mentioned above. However, other damage mechanisms may also be taken into account.

In accordance with common criteria for the best lifetime arrangement, small or big grain sizes of the applied alloy are convenient for minimizing damage rate of LCF or creep mechanism, respectively. Since the temperature and stress distribution within the mechanical component are non-uniform, like for instance in a gas turbine blade, some more specific rules for grain size in terms of a local component loading seems to be more adequate than these common well-known criteria.

Frequently, different parts of the same component can suffer either from LCF or from creep, and then more specific criteria of the grain size dependence of minimum LCF or creep rate are expected. Concerning only the creep mechanism, the creep rate can perform with respect to grain size in different manners as it is schematically illustrated in FIG. 4.

For higher temperatures above 0.5 Tₘ (where Tₘ denotes the absolute melting temperature of the alloy) and intermediate stress magnitudes σ, the creep rate decreases up to the specific value, which then remains constant independent on increasing grain size (see a solid curve A in FIG. 4). For this behavior, a dislocation climb mechanism dominates the creep deformation.

In the range of intermediate temperature varying between 0.4 and 0.5 Tₘ, and higher stresses, the creep rate shows a minimum value at a particular grain size of the alloy (see the dotted curve B in FIG. 4). For constant temperature and stress, the creep rate increases for higher grain sizes of the alloy. This damage mechanism can be explained by the Hall-Petch rule, which describes plastic flow for various grain sizes.

These considerations apply to the situation in a gas turbine. FIG. 1 schematically illustrates the one-dimensional (1D) radial distribution of temperature T and stress σ acting on a gas turbine blade rotating at the rotational speed Ω under the nominal operation conditions. In the gas turbine 10 of FIG. 1, 11 denotes a rotor rotating around a machine axis 21 with rotational speed Ω. A rotating blade 15 is mounted on the rotor 11 with a root 12. The blade 15 further comprises a shank 13, a platform 14 and an airfoil 22. Upstream of the blade 15 with respect to the hot gas flow 20, a (stationary) vane 16 is shown. The rotor 11 is surrounded by a stationary casing 17. 18 and 19 are circumferential and axial sealing systems, respectively, preventing from leakage of hot gas into the cooled lower part of the blade 15.

The gas turbine blade 15, which is schematically shown in FIG. 1, is an example of a mechanical component whose lifetime depends on the evaluated temperature, which generates non-uniform thermal stress distribution within the component. The rotating turbine blade 15 is additionally loaded by the centrifugal stresses that depend on radius r and rotational speed Ω (see left part of FIG. 1). The 1-dimensional centrifugal stresses σ achieve their maximum in root 12, which attaches blade 15 to the rotor 11.

The performance of a gas turbine engine increases with higher firing temperature in the combustor, and therefore vane 16 and blade 15 operate in the range of high temperatures close to Tₘ. To protect the blades and vanes from oxidation damage, they are covered by a thermal barrier coating (TBC) and in addition cooled internally by a coolant, such as either air provided from the compressor, or steam injected from other systems, like a steam turbine (in a combined-cycle environment). The coolant is redistributed under platform 14 of blade 15 to reduce the temperature of the shank section 13 and root part 12, where the stresses reach their maximum values due to the centrifugal loading (see FIG. 1).

The complex geometries of blade 15 and vane 16 match with requirements of the aerodynamic and mechanical integrity. Therefore, many geometrical notches are present within the blade and vane, thus inducing local stress concentrations.

The stresses σ and temperatures T acting on the blade 15 under the nominal boundary condition can be computed with a numerical approach, like e.g. the Finite Element Method (FEM), Boundary Element Method (BEM), and others. In addition, the temperatures and stresses are frequently measured in a prototyping process of the engine, and those experimental results are used for validation of the numerical values.

A metallurgical investigation of a component, which has been in service, provides an empirical assessment of the real temperatures in the system, which is also considered in the validation of the numerical model and its thermal boundary conditions. These three approaches or at least one of them can be used for creating a detailed map of the temperature and stress distribution within the whole component for the assessment of its lifetime.

Based on the described variation of the temperature T and mechanical stress σ (or/and strain ε) magnitudes within blade 15, which may lead either to LCF or creep damages, a controlled variation of optimal grain sizes of the alloy is a beneficial parameter for maximizing lifetime capability of the component made of the same alloy or different alloys.

Document U.S. Pat. No. 5,649,280 A describes a method of high retained strain forging for Ni-base superalloys, particularly those which comprise a mixture of gamma and gamma prime phases, and most particularly those which contain at least about 30 percent by volume of gamma prime. The method utilizes an extended subsolvus anneal to recrystallize essentially all of the superalloy and form a uniform, free grain size. Such alloys may also be given a supersolvus anneal to coarsen the grain size and redistribute the gamma prime. The method permits the manufacture of forged articles having a fine grain size in the range of about ASTM 5-12.

Document U.S. Pat. No. 5,759,305 A discloses a method of making Ni-base superalloy articles having a controlled grain size from a forging preform, comprising the steps of: providing a Ni-base superalloy preform having a recrystallization temperature, a gamma prime solvus temperature and a microstructure comprising a mixture of gamma and gamma prime phases, wherein the gamma prime phase occupies at least 30% by volume of the Ni-base superalloy; hot die forging the superalloy preform at a temperature of at least about 1600° F., but below the gamma prime solvus temperature and a strain rate from about 0.03 to about 10 per second to form a hot die forged superalloy work piece; isothermally forging the hot die forged superalloy work piece to form the finished article; supersolvus heat treating the finished article to produce a substantially uniform grain microstructure of about ASTM 6-8; cooling the article from the supersolvus heat treatment temperature.

Document U.S. Pat. No. 7,763,129 B2 teaches a method of forming a component from a gamma-prime precipitation-strengthened nickel-base superalloy so that, following a supersolvus heat treatment the component is characterized by a uniformly-sized grain microstructure. The method includes forming a billet having a sufficiently fine grain size to achieve superplasticity of the superalloy during a subsequent working step. The billet is then worked at a temperature below the gamma-prime solvus temperature of the superalloy so as to form a worked article, wherein the billet is worked so as to maintain strain rates above a lower strain rate limit to control average grain size and below an upper strain rate limit to avoid critical grain growth. Thereafter, the worked article is heat treated at a temperature above the gamma-prime solvus temperature of the superalloy for a duration sufficient to uniformly coarsen the grains of the worked article, after which the worked article is cooled at a rate sufficient to reprecipitate gamma-prime within the worked article.

Although these documents teach various methods for achieving a certain optimized grain size within a gas turbine component, or the like, there is no intent to establish, or knowledge about the advantages of, a specified local variation of the grain size within the component in accordance with the locally varying thermal and mechanical loads on that component.

### SUMMARY

In an embodiment, the present invention provides a component or coupon for use in a thermal machine under extreme thermal and mechanical conditions. The component or coupon comprises an alloy material having a controllable grain size (d). A grain size distribution (d(X,Y,Z)) of the component or coupon corresponds to at least one of an expected temperature distribution (T(X,Y,Z)), an expected stress distribution (σ(X,Y,Z)) and an expected strain distribution (ε(X,Y,Z)), which vary with geometrical coordinates (X,Y,Z) of the component or coupon, such that a lifetime of the component or coupon is improved with respect to a similar component or coupon having a substantially uniform grain size.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrated the one-dimensional (1D) radial distribution of temperature T and stress σ acting on a gas turbine blade rotating at the rotational speed Ω under the nominal operation conditions;

FIG. 2 shows a computed 3D temperature (T) distribution in a gas turbine blade in the Cartesian reference system (X,Y,Z), where different grey scales correspond to different temperature values;

FIG. 3 shows a computed 3D von-Mises stress (σ) distribution in a gas turbine blade in the Cartesian reference system (X,Y,Z), where different grey scales correspond to different stress values;

FIG. 4 shows two types of creep rate in terms of grain size, where each of the curves A, B represents the creep behavior for a constant temperature T and stress σ;

FIG. 5 shows an illustration of the process according to the invention based on the data from the 3D numerical results of temperature T(X,Y,Z), strain ε(X,Y,Z), stress σ(X,Y,Z) or/and other parameter distributions for producing of a component made of an alloy with controlled grain size d(X,Y,Z) within the alloy for obtaining optimized material properties under the operation condition of interest;

FIG. 6 shows a scheme of a suitable process apparatus for an SLM manufacturing process for the component (turbine blade) to be manufactured;

FIG. 7 shows a scheme of a suitable process apparatus with additional heating and/or cooling means for processing the component (turbine blade) to be manufactured; and

FIG. 8 shows a scheme of a suitable process apparatus, where the grain size distribution is generated by a local heat treatment of the manufactured component (turbine blade).

### DETAILED DESCRIPTION

In an embodiment, the present invention provides a component or coupon which is optimized in its internal structure with respect to the locally different thermal and mechanical loads.

Another embodiment of the invention provides a method for manufacturing such a component or coupon.

The component/coupon according to an embodiment of the invention is made of an alloy material with a controllable grain size, and is in service subjected to an expected temperature and/or stress and/or strain distribution, which varies with the geometrical coordinates of the component/coupon. It is characterized in that it has a grain size distribution, which depends on said expected temperature and/or stress and/or strain distribution such that the lifetime of the component is improved with respect to a similar component with a substantially uniform grain size.

According to another embodiment of the invention said component is a part of a gas turbine.

According to another embodiment of the invention said component is a rotating turbine blade.

According to a further embodiment of the invention said component or coupon is made of a superalloy.

According to another embodiment of the invention said component or coupon is made by an additive manufacturing process, especially selective laser melting (SLM).

The inventive method for manufacturing a component or coupon according to an embodiment of the invention comprises the steps of.

generating 1D or 2D or 3D parameter distribution data of one or more grain-size-relevant and lifetime-determining parameters for said component/coupon being under operating conditions; and

controlling during manufacturing of said component or coupon the grain size distribution within said component or coupon in order to maximize the lifetime of said component.

Grain-size-relevant means that the effect of these parameters on the component can be controlled by grain size.

According to an embodiment of the inventive method 3D parameter distribution data comprising a computed 3D temperature distribution and von Mises stress distribution are generated by a calculation, especially with a Finite Element Method (FEM).

According to another embodiment said component or coupon is manufactured by means of an additive manufacturing method, and the desired lifetime-maximizing grain size distribution is directly generated during said additive manufacturing process.

Preferably, said additive manufacturing method includes selective laser melting (SLM) of a suitable powder with a first laser beam, whereby the grain size is controlled by controlling the cooling rate of the melt pool within the SLM process.

Especially, the cooling rate of the melt pool within the SLM process is controlled by controlling the local thermal gradients at the melting zone.

Especially, the local thermal gradients at the melting zone are controlled by a second laser beam and/or a radiant heater.

According to another embodiment a substrate plate for the SLM process is used, which is heated or cooled by a heating or cooling medium to lower or increase said thermal gradients.

According to a further embodiment said component is manufactured with a homogeneous microstructure, and the desired lifetime-maximizing grain size distribution is generated after said manufacturing process.

Preferably, said lifetime-maximizing grain size distribution is generated by locally heating and/or cooling said component.

The present invention recognizes that the grain size has an impact on the lifetime of the component operating at elevated temperatures. An additive manufacturing process (selective laser sintering or melting (SLS or SLM), electron beam melting (EBM), 3D printing or other additive manufacturing processes) of the entire component or only its repair coupon is controlled in terms of the three-dimensional temperature T, strain ε or/and stress a distribution obtained from numerical, experimental, or/and empirical approaches. In the numerical or/and lifetime model of the component, the stress field is described with a vector of 6 stress components such as:
σₓₓ the normal stress in the X-direction of the Cartesian reference system,
σ_{yy} the normal stress in the Y-direction of the Cartesian reference system,
σ_{zz} the normal stress in the Z-direction of the Cartesian reference system,
σ_{xy} the shear stress on the XY-plane of the Cartesian reference system,
σ_{yz} the shear stress on the YZ-plane of the Cartesian reference system, and
σ_{zx} the shear stress on the ZX-plane of the Cartesian reference system.

Also, the strain state is defined in the same manner like the stress by using 3 normal εₓₓ, ε_{yy}, ε_{zz}, and 3 shear ε_{xy}, ε_{yz}, ε_{zx} strain components referred in the Cartesian reference system. By using the matrix notation, the relation between the stress and strain at every point of the component is determined for the three-dimensional stress field based on Hooke's law by

{σ}=[C]{ε}, (1)

where {σ} and {ε} are vectors of the six stress and strain components, whereby [C] denotes a (6×6) matrix, called the elastic stiffness, which in the general case of anisotropic materials, contains 36 elastic constants C_{i,j}, where i=1, 2, . . . , 6, and j=1, 2, . . . , 6. In case of an isotropic material, the matrix [C] is determined with Poisson's ratio v and Young modulus E(T), which depends on the metal temperature T.

In general, the stress and strain components depend on displacements (deformations) of an arbitrary point of the deformed part. These deformations are driven by the thermal expansion and/or mechanical loadings that can act as a static or dynamic pressure and/or forces on the component. The deformations of an arbitrary point are defined with the displacement vector {q}=col{qₓ, q_{y}, q_{z}}, determining displacements of this point in the Cartesian reference system along the X, Y, and Z axis, respectively. The relation of the strain to the deformation at an arbitrary point (X,Y,Z) of the part is defined by:

εₓₓ=∂qₓ/∂X, (2)

ε_{yy}=∂q_{y}/∂Y, (3)

ε_{zz}=∂q_{z}/∂Z, (4)

ε_{xy}=(∂qₓ/∂Y+∂q_{y}/∂X)/2, (5)

ε_{yz}=(∂q_{y}/∂Z+∂q_{z}/∂Y)/2, (6)

ε_{zx}=(∂q_{z}/∂X+∂qhd x/∂Z)/2. (7)

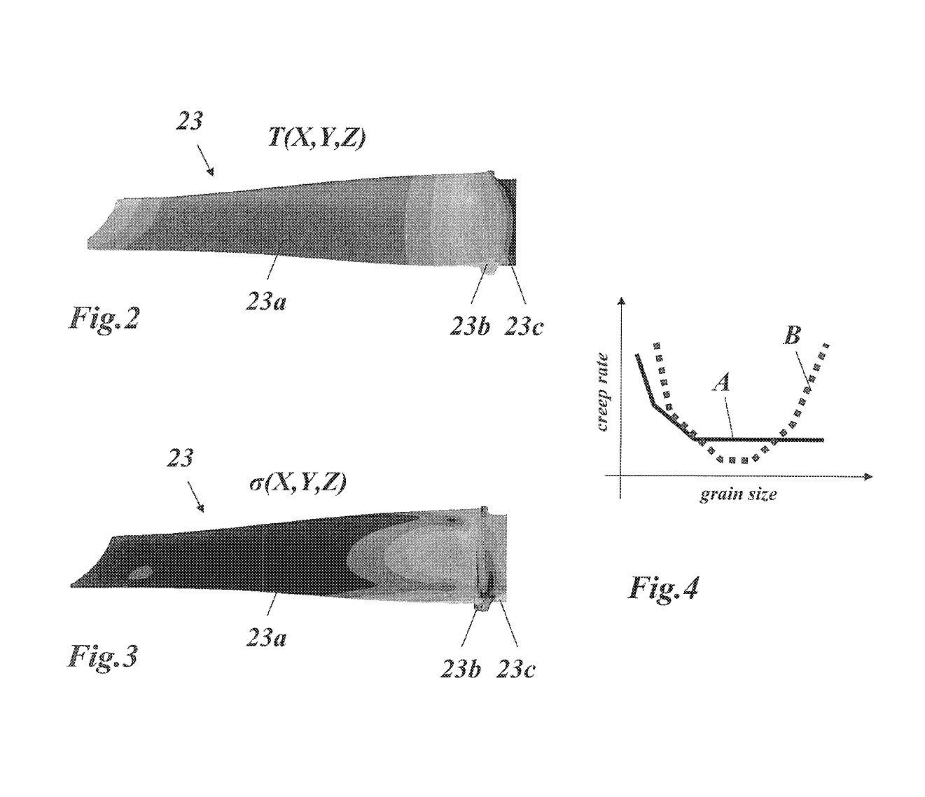

In the design process, the stress {σ}, strain {ε}, displacement {q} and temperature T of an arbitrary point are computed with an engineering software based on the Finite Element Methods, Boundary Element Methods, and others. A typical example of these analyses is shown in FIGS. 2 and 3 for the three-dimensional temperature (FIG. 2) and stress (FIG. 3) distribution of a gas turbine blade defined in the Cartesian reference system.

With respect to the temperature and stress distribution, these tools exactly predict the lifetime of the part using the failure mechanisms of creep, Low Cycle Fatigue, High Cycle Fatigue, Fracture Mechanic, Relaxation, and others. In order to include the grain size d of the polycrystalline materials, the general creep equation can be expressed by

dε_{c}/dt=(Cσ^{m}exp(−Q/kT))/d^{b} (8)

where ε_{c} denotes the creep strain, C means is a material constant of the specific creep mechanism, m and b are exponents dependent on the creep mechanism, Q corresponds to the activation energy of the creep mechanism, T is the absolute temperature at point (X,Y,Z), σ is the stress acting on the point (X,Y,Z) of interest, d is the size of the grain of the material, and k is Boltzmann's constant. In the literature, different models of the creep being dependent on the grain size are given are well-known.

Regarding the grain size d, the yield stress σₚ can be defined for instance by

σₚ=G b(ρ)^{1/2}+K/(d)^{1/2} (9)

where G is the shear modulus G(T)=E(T)/[2(1+v)] dependent on temperature T, b denotes Burger's vector, K means Hall-Petch coefficient, and ρ is the dislocation density.

By using the equations (8)-(9), or similar equations given in the literature or obtained from an internal investigation, a trend of the strain behaviors in terms of grain size d can be calculated with respect to the arbitrary position (X,Y,Z) of the part. For the component of interest, whose stress and temperature fields are computed with respect to the service conditions for maximizing the lifetime, the required grain size d is transferred to the manufacturing machine or processing apparatus, which produces the component with the locally controlled grain sizes d(X,Y,Z) dependent on the temperature T(X,Y,Z), stress σ(X,Y,Z) or/and strain ε(X,Y,Z) or other parameter based on the lifetime model.

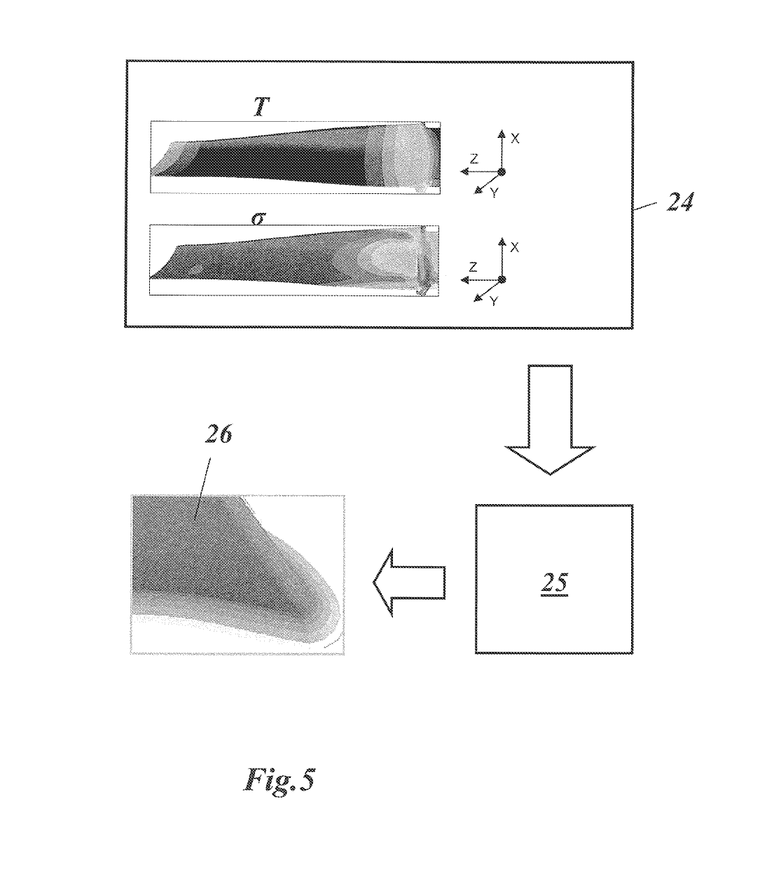

This process is illustrated in FIG. 5, where different technologies of additive manufacturing can be used. The process according to FIG. 5 is an additive manufacturing process or customized local heat treatment process based on 3D parameter distribution data 24 from the 3D finite element temperature T and stress σ results of the shrouded gas turbine blade under the nominal service condition.

The numerical model of temperature T(X,Y,Z), strain ε(X,Y,Z), stress σ(X,Y,Z) and other parameters is used for determining the demanded grain size d(X,Y,Z) resulting in the maximum lifetime of the part with respect to the desired operation conditions. The 3D parameter distribution data 24 are transferred to a processing apparatus 25, which processes the desired component 26.

In a preferred embodiment of this invention and representative for any potential additive manufacturing process, selective laser melting (SLM) is used to produce the mechanical component. Selective laser melting (SLM) is an additive manufacturing technology used to directly produce metallic parts from powder materials. As described for example in document U.S. Pat. No. 6,215,093 B1, thin powder layers with a thickness of typically between 20 μm to 60 μm are generated on a metallic base plate or the already produced fraction of an object, respectively. The cross-sections of a sliced CAD model stored in the SLM machine are scanned subsequently using a high power laser beam to compact the powder material. In general the STL-format is used to transfer the model geometry to the SLM machine.

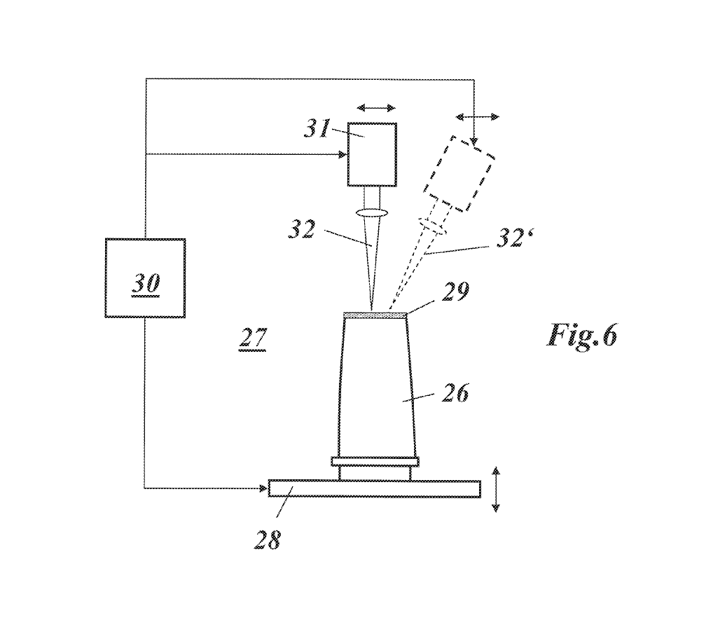

FIG. 6 shows a schematic diagram of a respective processing apparatus using SLM. The processing apparatus 27 of FIG. 6 comprises a displaceable substrate plate 28 for the processed and non-processed powder layers 29, which successively build up the component 26. A scanning focused laser beam 32 is generated by a laser source 31. Movement and power of the laser source 31 or laser beam 32 and movement of the substrate plate 28 are controlled by a control unit 30.

In an embodiment of the present invention the STL file mentioned above will be replaced accordingly by a CAD file including not only the geometrical information but also the temperature T(X,Y,Z), stress σ(X,Y,Z) or/and strain ε(X,Y,Z) or other parameter distribution based on the lifetime model. The optimal grain size distribution can then be derived from the above-mentioned information and equations. The optimal grain size d(X,Y,Z) can either be already included in the mentioned CAD file or can be calculated on the SLM machine (27) during processing.

To achieve the desired grain size d(X,Y,Z), the process parameters of the manufacturing process have to be adapted accordingly. This can be done for the whole layer or selectively. In general, the grain size correlates to the cooling rate of the melt pool within the SLM process: the higher the thermal gradient the smaller the resulting grain size, and vice versa. Therefore, the precise local adaption of the process parameters, such as but not limited to, laser power, laser mode (continuous wave or pulsed), laser focus diameter, scan speed and scan strategy is crucial to achieve the desired thermal gradient and grain sizes, respectively.

Further process equipment or processing apparatus can be used to better adjust local thermal gradients. In a preferred embodiment of this invention, a second laser beam 32′ (FIG. 6) is used to heat up surrounding material and therefore selectively lowering the local thermal gradients to achieve the desired grain sizes.

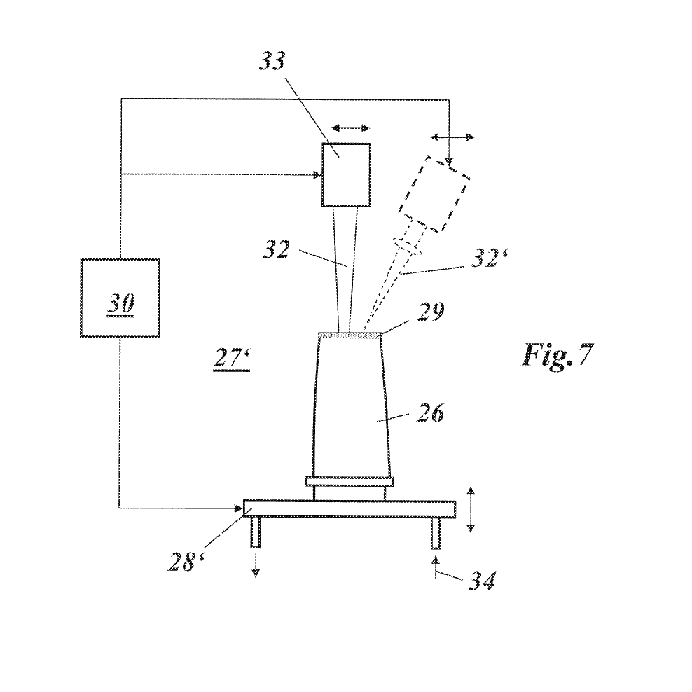

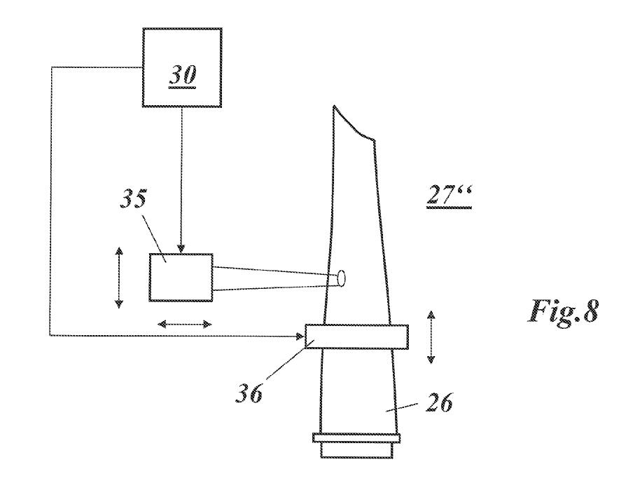

In another embodiment of this invention (FIG. 7) a radiant heater 33 can be used in the processing apparatus 27′ instead or in combination with the second laser beam 32′ to adjust the temperature distribution within the powder layer 29 or even within the whole process chamber. An example of such a radiant heater 33 is described in document EP 1 762 122 B2. Additionally, a substrate plate 28′ heated or cooled by a heating or cooling medium 34 (FIG. 7) can be used to lower or increase thermal gradients. An embodiment of such a heated substrate plate is described in document DE 101 04 732 C1. However, one skilled in the art may find other beneficial equipment helping to locally adjust thermal gradients, which are included herein as well.

By using the described method and means a component or its part can be produced with locally optimized grain sizes in respect to the local 6 normal and shear stresses {σ(X,Y,Z)} or strains {ε(X,Y,Z)} obtained from the 1 D, 2D, or 3D numerical simulations. Therefore, these components have superior lifetime compared to conventionally manufactured components.

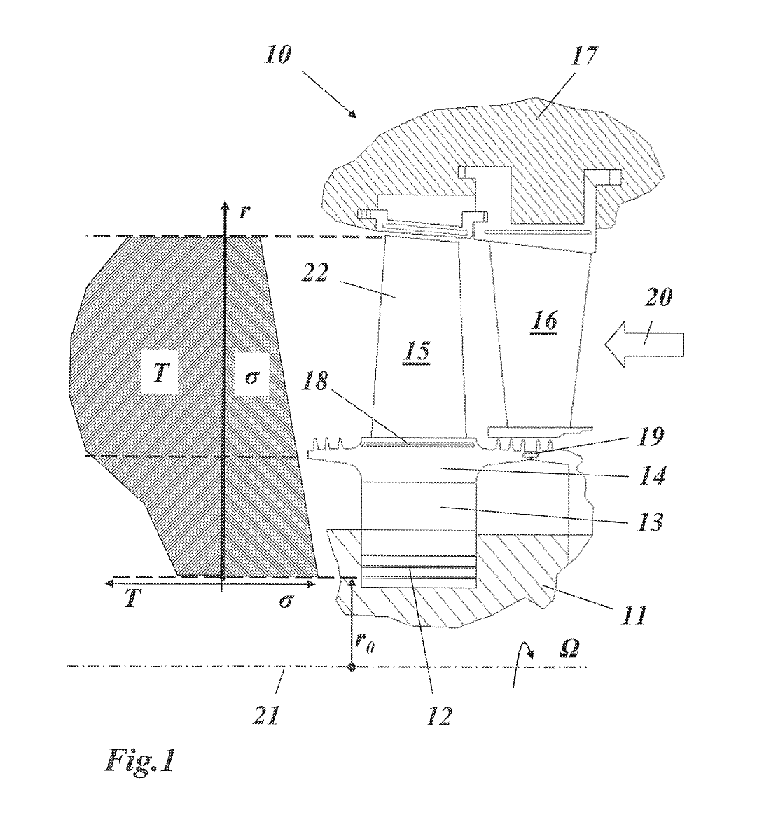

The description of the stress and/or strain field of the component/part can be simplified by other approaches. For instance, the stress and strain distribution can be represented by the average normal and shear stress or/and strain instead of digitalized stress σ(X,Y,Z) state of the component/part. In this case, the stress, temperature, strain and other parameters vary with respect to the one direction of the reference system like it is shown in FIG. 1, where stress a and temperature T vary in terms of the radial coordinate r. Also, different modeling methods of the stress/strain at the arbitrary point (X,Y,Z) can be used, for instance the principle stress/strain definition or others.

If the component or its repair coupon is produced with a homogenous microstructure of the alloy for a constant grain size, a customized and locally varying heat treatment can be applied according to FIG. 8. The component/part 26 is heat-treated in a processing apparatus 27″ with respect to a customized variation of grain sizes using the numerical, experimental or empirical results of temperature T and stress σ (or strain ε). A focal pointing heat generator 35 or/and a cooling system 36 could be considered as example of a device for generation of variable grain sizes within the produced component/part depending on the known temperature T and mechanical stress σ (or strain ε).

A suitable and exemplary alloy for a component or coupon (repair part of the component) according to the invention may be IN738LC. Other Ni base superalloys or superalloys on a different basis are also suitable.

The process of the additive manufacturing produces the object for the controlled local optimal grain sizes with respect to the expected loading. Arbitrary approaches, such as: different sizes of the metal powder applied to the process, adjusting laser power, and others may be taken in consideration, but are not presented here in detail for each process.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

### LIST OF REFERENCE NUMERALS

10 gas turbine
11 rotor
12 root
13 shank
14 platform
15 blade
16 vane
17 casing
18,19 sealing system
20 hot gas flow
21 machine axis
22 airfoil
23 blade
23a airfoil
23b platform
23c root
24 3D parameter distribution data
25,27,27′,27″ processing apparatus
26 component (part, coupon)
28 substrate plate (displaceable)
29 powder layer
30 control unit
31 laser source
32,32′ laser beam (focused)
33 radiant heater
34 cooling/heating medium
35 focal pointing heat generator
36 cooling system
A,B curve
r,r₀ radius
T temperature
σ stress
Ω rotational speed

1.-6. (canceled)

7. A method for manufacturing a component or coupon, comprising:
generating 1D, 2D or 3D parameter distribution data of at least one grain-size-relevant and lifetime-determining parameters (T, σ, ε etc.) of the component or coupon under operating conditions; and
controlling by a selective laser melting (SLM) process, during manufacturing of the component or coupon, a grain size distribution (d(X,Y,Z)) within the component or coupon so as to maximize a lifetime of the component or coupon.

8. The method according to claim 7, wherein the generating includes generating the 3D parameter distribution data including a computed 3D temperature distribution T(X,Y,Z) and von Mises stress distribution σ (X,Y,Z) using a calculation.

9. The method according to claim 8, wherein the calculation includes a Finite Elements Method (FEM).

10. The method according to claim 7, wherein the manufacturing of the component or coupon is performed using an additive manufacturing method, the grain size distribution (d(X,Y,Z)) being directly generated during the additive manufacturing process.

11. The method according to claim 10, wherein the additive manufacturing method includes the selective laser melting (SLM) process of a suitable powder with a first laser beam, a grain size (d) being controlled by controlling a cooling rate of a melt pool within the SLM process.

12. The method according to claim 11, wherein the cooling rate of the melt pool within the SLM process is controlled by controlling local thermal gradients at a melting zone.

13. The method according to claim 12, wherein the local thermal gradients at the melting zone are controlled by at least one of a second laser beam and a radiant heater.

14. The method according to claim 12, wherein the SLM process includes heating or cooling a substrate plate by a heating or cooling medium so as to lower or increase the local thermal gradients.

15. The method according to claim 7, wherein the manufacturing includes providing the component or coupon with a homogeneous microstructure, the grain size distribution (d(X,Y,Z)) being generated after the homogeneous microstructure has been created.

16. The method according to claim 15, wherein the grain size distribution (d(X,Y,Z)) is generated by at least one of locally heating and locally cooling the component or coupon.

17. The method according to claim 7, comprising:
forming the component or coupon from a nickel-based superalloy.

18. The method according to claim 17, wherein the nickel-based superalloy consists of the following chemical composition (amounts in % by weight):
0.09-0.13 Carbon,
3.00-9.00 Cobalt,
15.70-16.30 Chromium,
1.50-2.0 Molybdenum,
2.40-2.80 Tungsten,
1.50-2.00 Tantalum,
0.60-1.10 Columbium (Nibium),
3.20-3.70 Aluminum,
3.20-3.70 Titanium,
6.50-7.20 Alumium and Titanium,
0.0007-0.012 Boron,
0.03-0.08 Zirconium,
0.05 max Iron,
0.02 max Manganese,
0.03 max Silicon,
0.015 max Sulful, and
balance Nickel.
